(19) United States
(12) Patent Application Publication
(10) Pub. No.: US 2005/0108151 A1
(43) Pub. Date: May 19, 2005

(54) Order review workflow

(76) Inventor: Richard York, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/715,920

(22) Filed: Nov. 17, 2003

(51) Int. Cl. G06F 17/60

(52) U.S. Cl. 705/38

(57) ABSTRACT

An embodiment of the invention provides a method for an order review workflow, including: receiving an incoming order from a customer; applying fraud shield rules to the order and information of the customer, to determine if the order and customer information have information that matches a negative file; requesting a preauthorization from an issuing bank for funds to pay for the order; performing an address verification system (AVS) check on the customer; checking a card verification number (CVN) of a credit card of the customer; and applying a fraud analysis rule to the order to determine if an automatic-reject rule fires, if an outsort rule fires, or if a positive rule fires.

### TECHNICAL FIELD

Embodiments of the invention relate generally to the fraud prevention methods. More particularly, embodiments of the invention relate to order review workflows.

### BACKGROUND

An incoming order (e.g., an order for a particular product or service) may be placed by a customer via an online shopping website or via a call-center. Currently, when an incoming order is made by a customer, the incoming order will be reviewed for potential fraud by having an analyst examine the dollar amount of the incoming order. As a result, this current method is unable to detect for fraudulent orders that may have lower dollar amounts.

Additionally, in current methods and systems, a fraud analyst would review incoming orders in different manners, by different methodologies, and/or by use of different criteria. As a result, there was no consistency in the fraud review process.

Therefore, the current technology is limited in its capabilities and suffers from at least the above constraints and deficiencies. Thus, it would be desirable to improve the current methods for verifying an incoming order for potential fraud before the order is accepted or rejected.

### SUMMARY OF EMBODIMENTS OF THE INVENTION

In one embodiment of the invention, a method for an order review workflow, includes: receiving an incoming order from a customer; applying fraud shield rules to the order and information of the customer, to determine if the order and customer information have information that matches a negative file; requesting a preauthorization from an issuing bank for funds to pay for the order; performing an address verification system (AVS) check on the customer; checking a card verification number (CVN) of a credit card of the customer; and applying a fraud analysis rule to the order to determine if an automatic-reject rule fires, if an outsort rule fires, or if a positive rule fires.

In another embodiment, an apparatus an order review workflow, includes: a server including a transaction processing module configured to process an incoming order that is received from a call center or an online shopping website; the transaction processing module comprising an initial order review module configured to permit the above method steps.

Other embodiments of the invention include, but are not limited to, the various embodiments described below.

These and other features of an embodiment of the present invention will be readily apparent to persons of ordinary skill in the art upon reading the entirety of this disclosure, which includes the accompanying drawings and claims.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram of an apparatus, in accordance with an embodiment of the invention.

FIG. 2A is a high-level flowchart illustrating a method for an initial order review workflow, in accordance with an embodiment of the invention.

FIG. 2B is a flowchart illustrating additional details of a method for an initial order review workflow, in accordance with an embodiment of the invention.

### DETAILED DESCRIPTION OF PREFERRED EMBODIMENTS

In the description herein, numerous specific details are provided, such as examples of components and/or methods, to provide a thorough understanding of embodiments of the invention. One skilled in the relevant art will recognize, however, that an embodiment of the invention can be practiced without one or more of the specific details, or with other apparatus, systems, methods, components, materials, parts, and/or the like. In other instances, well-known structures, materials, or operations are not shown or described in detail to avoid obscuring aspects of embodiments of the invention.

Embodiments of the invention advantageously provide an apparatus, system, and method that provide an order initial review workflow for an incoming order for a service or product. This order initial review workflow permits the filtering of potentially fraudulent incoming orders that are received from a customer. In contrast, in current methods and systems, a fraud analyst would review incoming orders in different manners, by different methodologies, and/or by use of different criteria. As a result, in current methods and systems, there was no consistency in the fraud review process.

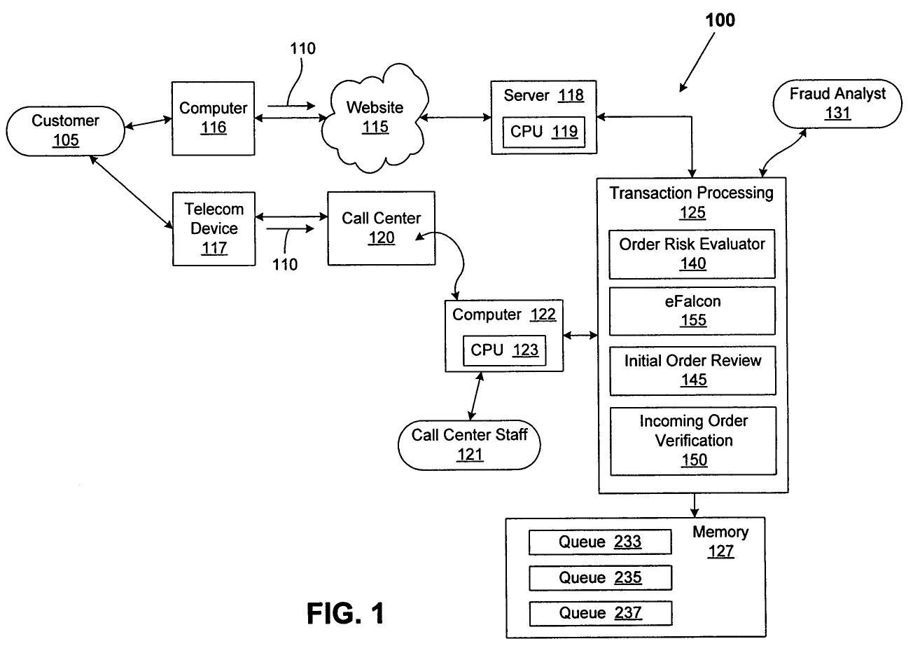

FIG. 1 is a block diagram of a system (or apparatus) 100 in accordance with an embodiment of the invention. A customer 105 may send an order 110 via an online shopping website 115 or may send the order 110 by calling a call-center 120. The order 110 may be, for example, an order for a particular product(s) and/or service(s). Typically, to send an order 110 to the online shopping website 115, the customer 105 will use a computer 116 to access and place the order 110 on the website 115. Typically, to send an order 110 to the call center 120, the customer 105 will use a telecommunication (telecom) device 117 (e.g., telephone or cellular phone) to place the order 110 to the call center 120.

The online shopping website 115 may be, for example, an online shopping website provided by HEWLETT-PACKARD COMPANY, Palo Alto, Calif., at <www.HPShopping.com>, other online shopping websites from other vendors or companies, an internal company shopping website, or another type of online shopping website.

Typically, a server 118 (or other suitable computing device) is used to implement the website 115 and to receive and process the order 110 from the customer 105. The server 118 includes a processor 119 (e.g., a central processing unit) for executing various applications or programs that are accessible by the server 118. Similarly, the customer's computer 116 will also include a processor (not shown in FIG. 1) for executing various applications or programs in the computer 116. Various known components that are used in the server 118 and in the user's computer 116 are not shown in FIG. 1 for purposes of focusing on the functionalities of embodiments of the invention.

A call center staff 121 in the call center 120 typically has access to a computer 122 for processing an incoming order 110 that is received in the call center 120. Typically, each call center staff 121 will have access to a separate computer 122. The computer 122 includes a processor 123 (e.g., a central processing unit) for executing various applications or programs that are accessible by the computer 122.

In an embodiment of the invention, a transaction processing module 125 is typically implemented within the server 118. However, the transaction processing module 125 may alternatively be implemented in another computer (not shown in FIG. 1) that is accessible by the server 118 and by the call center staff computer 122. An order risk evaluator 140 in the transaction processing module 125 can determine if the order 110 is a high risk order (i.e., an order with a high risk related to fraudulent activity), a medium risk order (i.e., an order with a medium risk related to fraudulent activity), or a low risk order (i.e., an order with a low risk related to fraudulent activity).

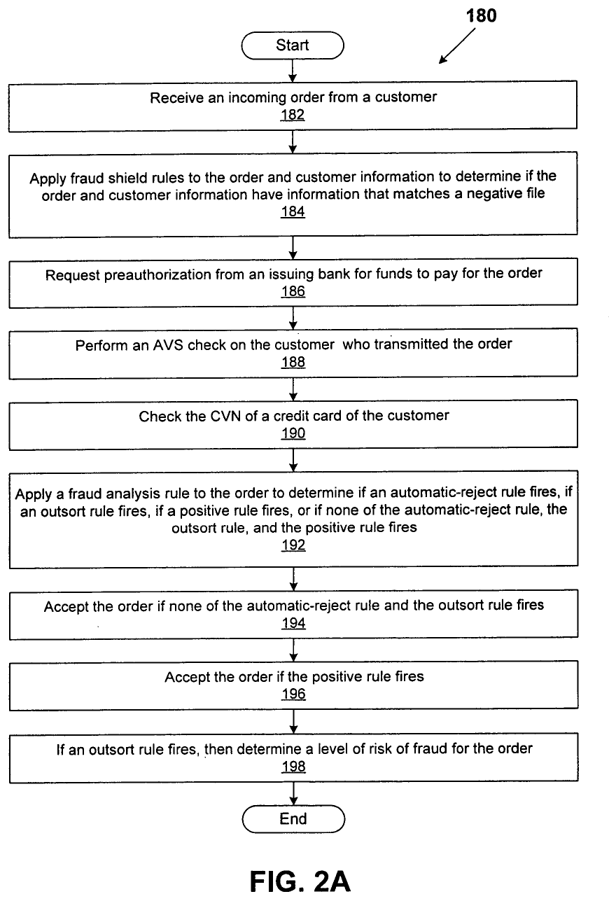

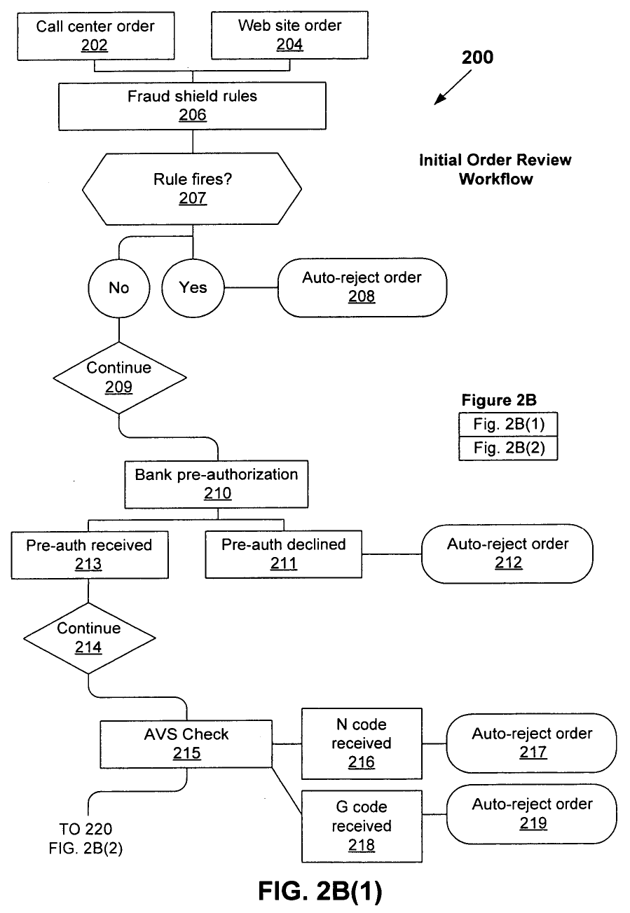

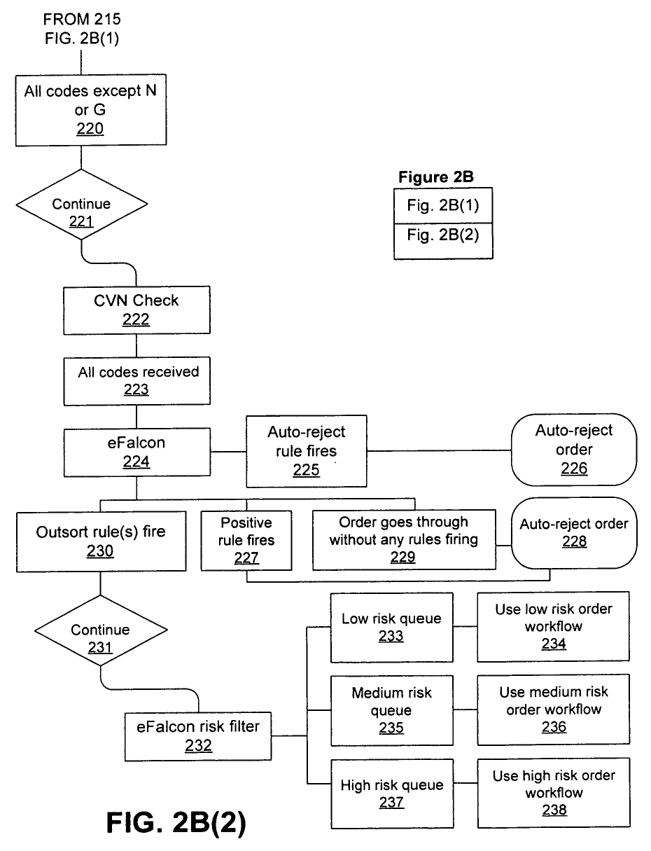

Typically, an initial order review workflow module 145 first outsorts an order 110 before the order 110 is determined as a high risk order, medium risk order, or low risk order. An order 110 is outsorted if the order 110 is selected among various incoming orders and placed in a separate queue (i.e., an outsort queue 233, 235, or 237 in FIG. 1 and FIG. 2B) where the order 110 can then be evaluated for risk related to fraudulent activity. Typically, these outsort queue 233, 235, and 237 are memory areas 126 in a memory 127. This memory 127 may be, for example, within the server 118, or within another computing device or memory storage device that can be accessed by the server 118 and call center staff computer 122.

The order risk evaluator 140 can categorize an incoming order 110 as a high risk order, medium risk order, or low risk order. In an embodiment, the order risk evaluator 140 is implemented as code that can be executed by a processor such as processor 119 in the server 118. In other embodiments, the order risk evaluator 140 may be implemented as a new code within an eFalcon module (or other fraud analysis module) 155 and executed by the eFalcon module 155 as a filter set to categorize an order 110 as a high risk order, medium risk order, or low risk order. The eFalcon module 155 is typically an e-commerce fraud detection product from, for example, FAIR, ISSAC AND COMPANY, San Rafael, Calif., and compares the transaction to general fraud patterns. In other embodiments, the order risk evaluator 140 may be independent from the eFalcon module 155 and the eFalcon module 155 may be omitted from the transaction processing module 125. In other embodiments, the order risk evaluator 140 can be implemented as a web tool that can be accessed by use of a web interface. In other embodiments, the order risk evaluator 140 can be implemented to function with a database, such as a database available from Oracle Corporation of Redwood Shores, Calif. An example of the order risk evaluator 140 is disclosed in, for example, U.S. patent application Ser. No. ______ by Richard York, entitled “ORDER RISK DETERMINATION”, which is hereby fully incorporated herein by reference. In other embodiments, the order risk evaluator 140 may be omitted in the transaction processing module 125, and the incoming order 110 may be manually classified as a high risk order, medium risk order, or low risk order based upon one or more criteria. For example, an incoming order 110 may be categorized as a high risk order if the order price amount exceeds a maximum threshold price amount (e.g., $500), may be categorized as a medium risk order if the order price amount is within a defined price range (e.g., between $100 and $500), and may be categorized as a low risk order if the order price amount is below a minimum threshold price amount (e.g., $100). Therefore, if the order 110 has a price amount of, for example, $510, then the order 110 is classified as a high risk order. If the order 110 has a price amount of, for example, $200, then the order 110 is classified as a medium risk order. If the order 110 has a price amount of, for example, $80, then the order 110 is classified as a low risk order.

As another example, an incoming order 110 may be categorized as a high risk order if the order quantity amount exceeds a maximum threshold quantity amount (e.g., 10 items), may be categorized as a medium risk order if the order quantity amount is within a defined range (e.g., between 5 items to 10 items), and may be categorized as a low risk order if the order quantity amount is below a minimum threshold amount (e.g., 5 items). Other criteria or a combination of criteria can be used to classify an order as a high risk order, medium risk order, or low risk order.

In an embodiment of the invention, an incoming order verification module 150 then provides a set of information to verify based upon the risk factor (i.e., low risk, medium risk, or high risk) associated with the incoming order 110, and verifies an appropriate set of information to determine if the order 110 is related to a potential fraudulent activity. An example of this verification method is disclosed in, for example, U.S. patent application Ser. No. ______ by Richard York, entitled “METHOD, APPARATUS, AND SYSTEM FOR VERIFYING INCOMING ORDERS”, which is hereby fully incorporated herein by reference. In other embodiments of the invention, the order risk evaluator 140 and incoming order verification module 150 may be omitted in the transaction processing module 125.

The modules in the transaction processing module 125 described above are typically implemented in software code.

FIG. 2A is a high-level flowchart illustrating a method 180 for an initial order review workflow, in accordance with an embodiment of the invention. Additional details of the method 180 are shown in method 200 in FIG. 2B. Particular steps in the method 180 may be executed by the initial order review workflow module 145 of FIG. 1, or the initial order review workflow module 145 is used to permit the analyst 131 to perform particular steps in the method 180. An incoming order 110 is received (182) from a customer. Fraud shield rules are then applied (184) to the order 110 and customer 105 information to determine if the order 110 and customer 105 information have information that matches a negative file. In one embodiment, if a fraud shield rule fires, then the order 110 is rejected or not approved.

The fraud analyst 131 can request (186) preauthorization from an issuing bank for funds to pay for the order 110. In one embodiment, if preauthorization is declined, then the order 110 is rejected.

The fraud analyst 131 can perform (188) an address verification system (AVS) check on the customer 105 who transmitted the order 110. In an embodiment, if the information provided by the customer 105 does not match the information in an issuing bank from a result of the AVS check or if the customer 105 is using a foreign credit card, then the order 110 is rejected. In another embodiment, then the analyst 131 can perform further analysis for fraud on the order 110 instead of automatically rejecting the order 110.

The fraud analyst 131 can check (190) the card verification number (CVN) of a credit card of the customer 105. In an embodiment, if there is a match in the CVN code, then the analyst 131 can approve the order 110. In an embodiment, if there is not a match in the CVN code, then the analyst 131 can perform further analysis for potential fraud on the order 110.

The initial order review module 145 can apply (192) a fraud analysis rule to the order 110 to determine if an automatic-reject rule fires, if an outsort rule fires, if a positive rule fires, or if none of the automatic-reject rule, the outsort rule, and the positive rule fires. If an automatic-reject rule fires, then the order 110 is rejected.

On the other hand, the order 110 is accepted (194) if none of the automatic-reject rule and the outsort rule fires.

Alternatively, the order 110 is also accepted (196) if a positive rule fires.

If an outsort rule fires, then a determination is made (198) on a level of risk of fraud for the order 110. In one embodiment, a determination is made if the order 110 should be classified as a high risk order, medium risk order, or low risk order, in order to classify a level of risk for fraud for the order.

FIG. 2B is a flowchart illustrating additional details of a method 200 for an initial order review workflow, in accordance with an embodiment of the invention. Particular steps in the method 200 may be executed by the initial order review workflow module 145 of FIG. 1, or the initial order review workflow module 145 is used to permit the analyst 131 to perform particular steps in the method 200.

An incoming order 110 is determined (202) as an order received via a call center 120 or is determined (204) as an order received via a web site 115. Fraud shield rules are then applied (206) to the incoming order 110. One product that implements the fraud shield rules is of the type available from, for example, CLEARCOMMERCE CORPORATION, Austin, Tex. A fraud shield rule product stores negative files. A negative file has, for example, a particular address and/or phone number associated with a past known fraudulent order. A check (207) is made to determine if a rule in the fraud shield rules fires (triggers). A fraud shield rule will fire if the incoming order has information matching information in the negative files. If a fraud rule fires, then the order is automatically rejected (208). If a fraud shield rule does not fire, then the method 200 proceeds (209) to block (210).

Pre-authorization will be requested (210) from an issuing bank (participating bank) for funds to pay for the order 110. If pre-authorization is declined (211), then the order is automatically rejected (212). Pre-authorization may be declined (211) if, for example, the customer for the incoming order does not have enough funds in the issuing bank to pay for the incoming order. On the other hand, if the pre-authorization is received (213), then the method 200 proceeds (214) to block (215).

An address verification system (AVS) check is then performed (215). The AVS code is a feature to verify the cardholder's address and zip code at the time of the transaction, and to verify if the information that the cardholder (customer 105) has entered matches the information that is stored at the issuing bank. If an “N” code is received (216), then the order is automatically rejected (217). If the AVS code is equal to “N”, which means that there was no match between the cardholder's address and the information stored at the issuing bank, then the order will be classified as a high risk order. As a result, the order will be automatically rejected (217).

If, after performing (215) the AVS check, a “G” code is received (218), then the order is automatically rejected (219). If the AVS code is equal to “G”, which means that the customer 105 is using a foreign credit card, then the order will be classified as a high risk order. As a result, the order will be automatically rejected (219).

In another embodiment, the order will not be automatically rejected if an N code or G code is received after performing (215) the AVS check. In this alternative embodiment, the analyst can perform further analysis for potential fraud, instead of automatically rejecting the order. Thus, blocks (216), (217), (218), and (219) may be omitted in other embodiments of the invention.

If, after performing (215) the AVS check, another code (except “N” or “G) is received (220), then the method 200 proceeds (221) to block (222).

The card verification number (CVN) authorization code is checked (222). Most credit cards now include a 3 or 4 digit card verification number, which is not part of the regular credit card number. Telephone and Internet merchants can use these numbers to verify that the card is in fact in the customer's hand as the CVN numbers are not embedded in the magnetic stripe of the card. A CVN authorization code equal to “N” means that there is no match found for the CVN code. In an embodiment, if there is a match in the CVN code, then the analyst 131 can approve the order 110. A CVN authorization code equal to “S” means that a verification system being used by the analyst is unable to verify the CVN code. The CVN code is received (223) after performing (222) the CVN check. In one embodiment, an order is not automatically cancelled in response to particular CVN codes such as code “N” or code “S”. Instead, in this embodiment, the CVN code is available for an analyst to consider when analyzing the incoming order for potential fraud.

A fraud analysis by use of the eFalcon product 155 (or other similar fraud analysis tool) is then performed (224), in order to determine if an automatic-reject rule fires, an outsort rule fires, or a positive rule fires. It is noted that this function by the efalcon product 155 of performing a fraud analysis may be performed by the initial order review module 145; therefore, the efalcon product 155 may be omitted in this alternative embodiment. If one of the automatic-reject rules fires, then the incoming order 110 is automatically rejected (226). An automatic-reject rule identifies a likelihood of fraudulent activity with the incoming order 110.

On the other hand, if a “positive rule” fires (227) after performing the analysis under the eFalcon product 155, then the order 110 is automatically accepted (228). A positive rule permits an order 110 to be automatically accepted, since the event associated with the triggering of the positive rule makes it very unlikely that a fraudulent activity is associated with the incoming order 110. For example, a positive rule is triggered if the incoming order 110 is made from an internal website of the vendor (e.g., an order 110 for a Hewlett-Packard product is made from a Hewlett-Packard employee internal website). As another example, if the credit card number (that is used for the incoming order 110) belongs to a customer satisfaction group (or other pre-selected group) of the vendor, then a positive rule is triggered, where the customer satisfaction group orders replacement products for the vendor. Activities from these pre-selected groups of the vendor are unlikely related to fraudulent activities. Other events can be associated with the firing of a positive rule(s).

On the other hand, if an outsort rule(s) fires (230), then the method 200 proceeds (231) to the risk filter analysis block (232). The risk filter analysis block (typically implemented by the order risk evaluator 140 in FIG. 1) analyzes and assigns the level of risk for fraud for an incoming order 110. An order 110 can be selected for outsort by use of any suitable methods, such as, for example, outsorting all incoming orders 110, outsorting randomly picked incoming orders 110, outsorting an incoming order 110 based upon one or more criteria that can be predefined by the user of the transaction processing module 125, and/or outsorting an incoming order 110 based upon other suitable methods.

Alternatively, if a positive rule or an outsort rule(s) or an automatic-reject rule(s) fails (229) to fire for the incoming order, then the order is automatically accepted or approved (228). In other words, in block (229), the order has gone through without any rules firing.

If, in step (230) an outsort rule(s) fires for the order 110, the risk factor to assign to the incoming order 110 is then determined (232), by use of a risk filter as described in, for example, the above-referenced patent application entitled “ORDER RISK DETERMINATION” by Richard York. As previously noted above, other methods may be used to determine the particular risk factor that will be assigned to the order 110. If the incoming order 110 is categorized as a low risk order (i.e., placed in a low risk queue (233) in FIG. 1), then the order is analyzed (234) for potential fraud by use of a low risk order workflow as described in, for example, the above-mentioned U.S. patent application Ser. No. ______ by Richard York, entitled “METHOD, APPARATUS, AND SYSTEM FOR VERIFYING INCOMING ORDERS”. If the incoming order is categorized as a medium risk order (i.e., placed in a medium risk queue (235)), then the order is analyzed (236) for potential fraud by use of the medium risk order workflow as described in, for example, the above-mentioned U.S. patent application Ser. No. ______ by Richard York, entitled “METHOD, APPARATUS, AND SYSTEM FOR VERIFYING INCOMING ORDERS”. If the incoming order is categorized as a high risk order (i.e., placed in a high risk queue (237)), then the order is analyzed (238) for potential fraud by use of the high risk order workflow as described in, for example, the above-mentioned U.S. patent application Ser. No. ______ by Richard York, entitled “METHOD, APPARATUS, AND SYSTEM FOR VERIFYING INCOMING ORDERS”. Other suitable methods may be used to analyze a high risk order, medium risk order, or low risk order.

The system of certain embodiments of the invention can be implemented in hardware, software, or a combination thereof. In at least one embodiment, the system is implemented in software or firmware that is stored in a memory and that is executed by a suitable instruction execution system. If implemented in hardware, as in an alternative embodiment, the system can be implemented with any suitable technology as known to those skilled in the art.

The various engines discussed herein may be, for example, software, commands, data files, programs, code, modules, instructions, or the like, and may also include suitable mechanisms.

Reference throughout this specification to “one embodiment”, “an embodiment”, or “a specific embodiment” means that a particular feature, structure, or characteristic described in connection with the embodiment is included in at least one embodiment of the present invention. Thus, the appearances of the phrases “in one embodiment”, “in an embodiment”, or “in a specific embodiment” in various places throughout this specification are not necessarily all referring to the same embodiment. Furthermore, the particular features, structures, or characteristics may be combined in any suitable manner in one or more embodiments.

Other variations and modifications of the above-described embodiments and methods are possible in light of the foregoing teaching.

Further, at least some of the components of an embodiment of the invention may be implemented by using a programmed general purpose digital computer, by using application specific integrated circuits, programmable logic devices, or field programmable gate arrays, or by using a network of interconnected components and circuits. Connections may be wired, wireless, by modem, and the like.

It will also be appreciated that one or more of the elements depicted in the drawings/figures can also be implemented in a more separated or integrated manner, or even removed or rendered as inoperable in certain cases, as is useful in accordance with a particular application.

It is also within the scope of the present invention to implement a program or code that can be stored in a machine-readable medium to permit a computer to perform any of the methods described above.

Additionally, the signal arrows in the drawings/Figures are considered as exemplary and are not limiting, unless otherwise specifically noted. Furthermore, the term “or” as used in this disclosure is generally intended to mean “and/or” unless otherwise indicated. Combinations of components or actions will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

1. A method for an order review workflow, the method comprising:
receiving an incoming order from a customer;
applying fraud shield rules to the order and information of the customer, to determine if the order and customer information have information that matches a negative file;
requesting a preauthorization from an issuing bank for funds to pay for the order;
performing an address verification system (AVS) check on the customer;
checking a card verification number (CVN) of a credit card of the customer; and
applying a fraud analysis rule to the order to determine if an automatic-reject rule fires, if an outsort rule fires, or if a positive rule fires.

2. The method of claim 1, further comprising:
rejecting the order if one of the fraud shield rules fires.

3. The method of claim 1, further comprising:
rejecting the order if the preauthorization is declined.

4. The method of claim 1, further comprising:
rejecting the order if the information provided by the customer does not match the information in the issuing bank from a result of the AVS check.

5. The method of claim 1, further comprising:
rejecting the order if the customer is using a foreign credit card.

6. The method of claim 1, further comprising:
performing further analysis for fraud on the order, if the information provided by the customer does not match the information in the issuing bank from a result of the AVS check or if the customer is using a foreign credit card.

7. The method of claim 1, further comprising:
approving the order if there is a match in the CVN check.

8. The method of claim 1, further comprising:
performing further analysis for potential fraud on the order if there is not a match in the CVN code during the CVN check.

9. The method of claim 1, further comprising:
rejecting the order if an automatic-reject rule fires.

10. The method of claim 1, further comprising:
accepting the order if none of the automatic-reject rule and the outsort rule fires.

11. The method of claim 1, further comprising:
accepting the order if a positive rule fires.

12. The method of claim 1, further comprising:
determining a level of risk of fraud for the order, if an outsort rule fires.

13. The method of claim 12, wherein determining the level of risk of fraud for the order comprises:
determining if the order should be classified as a high risk order, medium risk order, or low risk order.

14. The method of claim 1, wherein the order is received in a website.

15. The method of claim 1, wherein the order is received in a call center.

16. The method of claim 1, wherein the order is an order for a product.

17. The method of claim 1, wherein the order is an order for a service.

18. An apparatus for an order review workflow, the apparatus comprising:
a server including a transaction processing module configured to process incoming orders received from a call center or an online shopping website, the transaction processing module comprising: an initial order review module configured to permit the steps comprising:
receiving an incoming order from a customer;
applying fraud shield rules to the order and information of the customer, to determine if the order and customer information have information that matches a negative file;
requesting a preauthorization from an issuing bank for funds to pay for the order;
performing an address verification system (AVS) check on the customer;
checking a card verification number (CVN) of a credit card of the customer; and
applying a fraud analysis rule to the order to determine if an automatic-reject rule fires, if an outsort rule fires, or if a positive rule fires.

19. The apparatus of claim 18, wherein the order is rejected if one of the fraud shield rules fires.

20. The apparatus of claim 18, wherein the order is rejected if the preauthorization is declined.

21. The apparatus of claim 18, wherein the order is rejected if the information provided by the customer does not match the information in the issuing bank from a result of the AVS check.

22. The apparatus of claim 18, wherein the order is rejected if the customer is using a foreign credit card.

23. The apparatus of claim 18, wherein further analysis for fraud is performed on the order, if the information provided by the customer does not match the information in the issuing bank from a result of the AVS check or if the customer is using a foreign credit card.

24. The apparatus of claim 18, wherein the order is approved if there is a match in the CVN check.

25. The apparatus of claim 18, wherein further analysis for potential fraud is performed on the order if there is not a match in the CVN code during the CVN check.

26. The apparatus of claim 18, wherein the order is rejected if an automatic-reject rule fires.

27. The apparatus of claim 18, wherein the order is accepted if none of the automatic-reject rule and the outsort rule fires.

28. The apparatus of claim 18, wherein the order is accepted if a positive rule fires.

29. The apparatus of claim 18, wherein a level of risk of fraud is determined for the order, if an outsort rule fires.

30. The apparatus of claim 29, wherein the level of risk of fraud determined for the order comprises a high risk order, medium risk order, or low risk order.

31. The apparatus of claim 18, wherein the order is received in a website.

32. The apparatus of claim 18, wherein the order is received in a call center.

33. The apparatus of claim 18, wherein the order is an order for a product.

34. The apparatus of claim 18, wherein the order is an order for a service.

35. An apparatus for an order review workflow, the apparatus comprising:
means for receiving an incoming order from a customer;
means for applying fraud shield rules to the order and information of the customer, to determine if the order and customer information have information that matches a negative file;
means for requesting a preauthorization from an issuing bank for funds to pay for the order;
means for performing an address verification system (AVS) check on the customer;
means for checking a card verification number (CVN) of a credit card of the customer; and
means for applying a fraud analysis rule to the order to determine if an automatic-reject rule fires, if an outsort rule fires, or if a positive rule fires.

36. An article of manufacture, comprising:
a machine-readable medium having stored thereon instructions to:
receive an incoming order from a customer;
apply fraud shield rules to the order and information of the customer, to determine if the order and customer information have information that matches a negative file;
request a preauthorization from an issuing bank for funds to pay for the order;
perform an address verification system (AVS) check on the customer;
check a card verification number (CVN) of a credit card of the customer; and
apply a fraud analysis rule to the order to determine if an automatic-reject rule fires, if an outsort rule fires, or if a positive rule fires.
